(19) United States
(12) Patent Application Publication
(10) Pub. No.: US 2006/0089293 A1
(43) Pub. Date: Apr. 27, 2006

(54) Concentrated fabric softener active compositions

(76) Inventor: Gayle Marie Frankenbach, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/252,654

(22) Filed: Oct. 18, 2005

Related U.S. Application Data
(60) Provisional application No. 60/619,804, filed on Oct. 18, 2004.

(51) Int. Cl. C11D 3/00

(52) U.S. Cl. 510/515

(57) ABSTRACT

Fabric softening active composition comprising (a) at least about 20% to less than 100% fabric softener active and (b) solvent or combination of solvents wherein at least one of the solvents has a Clog P of from about −2 to about 2, are cost-effective for transporting to developing markets.

### CROSS REFERENCE TO RELATED APPLICATIONS

This application claims priority to U.S. Provisional Application Ser. No. 60/619,804, filed Oct. 18, 2004, the disclosure of which is incorporated by reference herein.

### FIELD OF INVENTION

The present invention relates to concentrated liquid fabric softener actives and/or premixes for use in preparing softening compositions useful for softening cloth. It also relates to the preparation of textile softening compositions for use in the rinse cycle of a home textile laundering operation to provide excellent fabric-softening/static-control benefits.

### BACKGROUND OF THE INVENTION

Fabric softening compositions containing high solvent levels are known in the art. However, there is a need for compositions that are highly concentrated in fabric softener active (FSA) and are, in effect, premixes of a fabric softener active (FSA) and solvent that can be used to form finished compositions that are suitable for sale to consumers. Said highly concentrated FSA compositions are liquid at a lower temperature (e.g., 85° C.) than the solvent-free fabric softener active to provide ease of processing. Suitable highly concentrated FSA compositions also have a high flash point (e.g., 38° C.). These aspects of concentrated FSA composition are of particular importance when one wants to provide the fabric softening benefit to consumers in developing markets, where the cost of transporting finished product to the area from some other location is prohibitively expensive and the local manufacturing facilities are limited and rudimentary.

A concentrated composition is disclosed in the patent application WO 0980824 A2 by E. Wahl et al. published 5 Mar. 1998. This composition is limited to using unsaturated fabric softener actives with a very limited solvent range to achieve a concentrated FSA that is liquid at room temperature. Now it is surprisingly found that more saturated fabric softener actives are suitable for use for making concentrated FSA compositions with solvent because the melting point of the active is suitably lowered to allow processing at a temperature below that at which the fabric softener alone would melt. Additionally the present invention allows for the use of less expensive solvents, such as the glycol ethers which are ostensibly excluded in WO090824A2 as unsuitable. It is surprisingly and importantly found for the present invention that a much broader group of solvents is suitable for forming a concentrated FSA composition since this allows for economizing on the cost of the solvent, an aspect critically important for developing regions with low manufacturing capability. Additionally, the present invention surprisingly finds that suitable concentrated FSA compositions can be made with more saturated fabric softener actives which tend to be more efficient at delivering a softness benefit that unsaturated fabric softener actives and thus again the saturated fabric softener actives allow a more economical fabric softener formulation to be made in developing countries that face economic challenges in the market place.

A concentrated composition is disclosed in U.S. Pat. No. 5,861,370, by T. Trinh, et al. granted 19 Jan. 1999. The concentrated composition, or premix, of '370 requires perfume as an essential ingredient of the composition. Perfume may prove to be a cost prohibitive approach to concentrating FSA composition in developing markets. In the concentrated FSA compositions of the present invention, only solvent is an essential ingredient to lower the temperature at which the FSA composition is liquid and provide for ease of processing the said concentrated composition, if indeed the concentrated composition of the present invention is not already liquid. Thus the concentrated composition of the present invention provides a means for generating a flexible basic or “base” fabric softening composition upon dilution of the liquid or melted composition together with stirring to form a dispersed lamellar phase that can be then be differentiated with a variety of additional elements, including perfume, adjunct softening actives, bluing, brighteners, etc. One skilled in the art will appreciate that generating a basic or “base” composition that can be differentiated as a last step reduces complexity involved with processing a number of variants which is of particular importance when manufacturing capability is low such as in a developing market.

The present invention provides highly concentrated FSA composition comprising fabric softener actives that are preferably biodegradable actives with relatively low, organic solvent level (i.e. below about 50%, and preferably below about 40% by weight of the composition), that have are liquid at a lower temperature than the solvent-free fabric softener active, and have a high flash point. The concentrated FSA compositions disperse in water, and upon melting can be processed at preferably without high shearing and at temperature lower than the solvent-free quat, to form stable fabric softening compositions wherein the majority of the dispersed particles size of less than about 1000 micron, preferably less than about 100 micron, more preferably less than about 10 micron, even more preferably less than about 3 micron and the viscosity of said fabric softening compositions is less than about 500 cPs, preferably less than about 300 cPs and more preferably less than 200 cPs and typically greater than about 20 cPs, preferably greater than about 50 cPs.

### SUMMARY OF THE INVENTION

The present invention relates to a concentrated fabric softener active (FSA) composition. The composition of the present invention comprises at least about 20%, preferably at least about 30%, more preferably at least about 50%, even more preferably at least about 60% and most preferably at least about 70% fabric softener active by weight of the composition. Typically said concentrated compositions of the present invention comprises less than 100%, preferably less than 90%, and most preferably less than about 85% of a fabric softener active by weight of the said concentrated composition. The concentrated FSA composition of the present invention also comprises a solvent or combination of solvents wherein each of the said solvents have a Clog P of from about −2 to 2. The concentrated FSA composition of the present invention has a flash point of above about 38° C., preferably above about 90° C. as measured using the closed cup flash point methodology. The concentrated FSA composition of the present invention achieves a liquid state, as measured by a viscosity, as measured on a Brookhaven viscometer, of typically less than 500 cPs, preferably less than 400 cPs, more preferably less than 300 cPs at a temperature of typically ≦about 80° C., preferably ≦about 70° C., more preferably ≦about 40° C., more preferably ≦about 30° C., most preferably at a temperature less than about ≦about 25° C.

For the present invention, it is acceptable for the composition to have a range of visco-elastic properties from purely a liquid to purely a solid. In one embodiment, the composition of the present invention is a liquid, In another embodiment, the composition is a gel. In yet another embodiment, the composition is a solid.

The said concentrated FSA compositions disperse in water, and upon melting can be processed at preferably without high shearing and at temperature lower than the solvent-free quat, to form stable fabric softening compositions wherein the majority of the dispersed particles size of less than about 1000 micron, preferably less than about 100 micron, more preferably less than about 10 micron, even more preferably less than about 3 micron and the viscosity of said fabric softening compositions is less than about 500 cPs, preferably less than about 300 cPs and more preferably less than 200 cPs and typically greater than about 20 cPs, preferably greater than about 50 cPs.

The composition of the present invention can also optionally comprise the following: an aqueous carrier, adjunct fabric softening actives such as cationic starch, clay, or silicone, electrolyte, bilayer stabilizer, cationic polymers, agents to adjust pH, perfume, dye, bluing, brightener, preservative, clay, silicone, or combinations thereof.

### DETAILED DESCRIPTION OF THE INVENTION

The present invention relates to a concentrated fabric softener active (FSA) composition. The composition of the present invention comprises a fabric softening active and a solvent and the said concentrated composition has a low melting point and it is non-flammable. In one preferred embodiment of the present invention the said concentrated composition generates a composition comprising dispersed lamellar liquid crystalline particles upon dilution into water. In another embodiment of the present invention, the said concentrated composition generates a clear or translucent composition on dilution into water.

The composition of the present invention can also optionally comprise the following: an aqueous carrier, adjunct fabric softening actives such as cationic starch, clay, or silicone, electrolyte, bilayer stabilizer, cationic polymers, agents to adjust pH, perfume, dye, bluing, brightener, preservative, clay, silicone, or combinations thereof.

### I. The Concentrated Fabric Softener Active (FSA) Composition

The present invention relates to a concentrated fabric softener active (FSA) composition. The composition of the present invention comprises at least about 20%, preferably at least about 30%, more preferably at least about 50%, even more preferably at least about 60% and most preferably at least about 70% FSA by weight of the composition. Typically the composition of the present invention comprises less than 100%, preferably less than 90%, and most preferably less than about 85% of a FSA by weight of the composition. The composition comprises by weight.

Fabric softening actives suitable for the concentrated fabric softening composition of the present invention are described herein below.

A. Fabric Softening Active

In one embodiment of the invention, the FSA is a quaternary ammonium compound suitable for fabric softening.

Diester Quaternary Ammonium (DEQA) Compounds

In one embodiment, the fabric softening active comprises a DEQA compound. The DEQA compounds encompass a description of diamido fabrics softener actives as well as FSAs with mixed amido and ester linkages.

A first type of DEQA (“DEQA (1)”) suitable as a fabric softening active in the present compositions includes compounds of the formula:
{R₄₋ₘ—N⁺—[(CH₂)ₙ—Y—R¹]ₘ}X⁻
wherein each R substituent is either hydrogen, a short chain C₁-C₆, preferably C₁-C₃ alkyl or hydroxyalkyl group, e.g., methyl (most preferred), ethyl, propyl, hydroxyethyl, and the like, poly (C₂₋₃ alkoxy), preferably polyethoxy, group, benzyl, or mixtures thereof; each m is 2 or 3; each n is from 1 to about 4, preferably 2; each Y is —O—(O)C—, —C(O)—O—, —NR—C(O)—, or —C(O)—NR— and it is acceptable for each Y to be the same or different; the sum of carbons in each R¹, plus one when Y is —O—(O)C— or —NR—C(O)—, is C₁₂-C₂₂, preferably C₁₄-C₂₀, with each R¹ being a hydrocarbyl, or substituted hydrocarbyl group; it is acceptable for R¹ to be unsaturated or saturated and branched or linear and preferably it is linear; it is acceptable for each R¹ to be the same or different and preferably these are the same; and X⁻ can be any softener-compatible anion, preferably, chloride, bromide, methylsulfate, ethylsulfate, sulfate, phosphate, and nitrate, more preferably chloride or methyl sulfate. Preferred DEQA compounds are typically made by reacting alkanolamines such as MDEA (methyldiethanolamine) and TEA (triethanolamine) with fatty acids. Some materials that typically result from such reactions include N,N-di(acyl-oxyethyl)-N,N-dimethylammonium chloride or N,N-di(acyl-oxyethyl)-N,N-methylhydroxyethylammonium methylsulfate wherein the acyl group is derived from animal fats, unsaturated, and polyunsaturated, fatty acids, e.g., oleic acid, and/or partially hydrogenated fatty acids, derived from vegetable oils and/or partially hydrogenated vegetable oils, such as, canola oil, safflower oil, peanut oil, sunflower oil, corn oil, soybean oil, tall oil, rice bran oil, etc. Non-limiting examples of suitable fatty acids are listed in U.S. Pat. No. 5,759,990 at column 4, lines 45-66. Those skilled in the art will recognize that active softener materials made from such process can comprise a combination of mono-, di-, and tri-esters depending on the process and the starting materials. Materials from this group preferred for the present invention include those comprising a high level of diester content; typically greater than 40%, preferably greater than 55%, still more preferably greater than 60%, of the total softener active weight (as used herein, the total softener active weight includes the mass encompassing all reaction products that comprise one or more R¹ groups, the percent softener active as used herein to quantify the individual percentages of mono-, di-, and tri-tail reaction products refers to the ratio of an individual portion (mass) of the total softener active wherein the constituents contain a common number of R¹ groups divided by the total softener active weight and multiplied by 100 to give a percentage of the total.) In one preferred embodiment, the diester content comprises from about 60% to about 75% of the total percent of softener active weight. In another preferred embodiment the diester content comprises from about 75% to 90% of the total percent of softener active weight. Materials from this group preferred for the present invention also include those comprising a low level of monoester content; preferably less than about 40% of the total percent of softener active weight. In a preferred embodiment, where the concentrated module is used to make a fabric conditioner product the monoester content comprises from about 15% to about 40% of the total percent of softener active weight. In another embodiment, the monoester content comprises more than about 1%, preferably more than about 5%, most preferably about 10% and less that about 15% of the total percent of softener active weight. For a preferred embodiment of the present invention when the concentrated module is used to make a fabric softening composition that is used in conditions where carry-over of anionic surfactant occurs, the mole ratio of the monoester to diester species is typically 1 to ≦about 1.5, preferably 1 to ≦about 1.4, and most preferably 1 to ≦about 1.3 moles of monoester to moles of diester species; it is further preferred for this embodiment for the mole ratio of monoester to diester to be 1 to ≧1 moles of monoester to moles of diester. Non-limiting examples of preferred diester quats for the present invention include N,N-di(tallowoyloxyethyl)-N,N-dimethylammonium chloride (available from Akzo under the trade name Armosoft® DEQ) and N,N-di(canola-oyloxyethyl)-N,N-dimethylammonium chloride (available from Degussa under the trade name Adogen® CDMC). Nonlimiting examples of available TEA ester quats suitable for the present invention include di-(hydrogenated tallowoyloxyethyl)-N,N-methylhydroxyethylammonium methylsulfate and di-(oleoyloxyethyl)-N,N-methylhydroxyethylammonium methylsulfate sold under the trade names Rewoquat® WE 15 and Varisoft® WE 16, both available from Degussa.

Additional preferred DEQA (1) actives include compounds comprising different Y structures such as the those having the structure below where one Y=—C(O)—O— and the other Y=—NH—C(O)—:
R¹—C(O)O—R²—N⁺(R⁴)ₙ—R³—N(H)—C(O)—R¹X⁻
wherein n is 1 or 2; R¹ is a C₆-C₂₂, preferably a C₈-C₂₀, hydrocarbyl group or substituted hardrocarbyl groups that are branched or unbranched and saturated or unsaturated; R² and R³ are each C₁-C₅, preferably C₂-C₃, alkyl or alkylene groups; and R⁴ is H, or a C₁-C₃ alkyl or hydroxyalkyl group. A non-limiting example of such softener is N-tallowoyloxyethyl-N-tallowoylaminopropyl methyl amine. Additional non-limiting examples of such softeners are described in U.S. Pat. No. 5,580,481 and U.S. Pat. No. 5,476,597.

Other suitable fabric softening actives include reaction products of fatty acids with dialkylenetriamines in, e.g., a molecular ratio of about 2:1, said reaction products containing compounds of the formula:
R¹—C(O)—NH—R²—NH—R³—NH—C(O)—R¹
wherein R¹, R² are defined as above, and each R³ is a C₁₋₆ alkylene group, preferably an ethylene group. Examples of these fabric softening actives are reaction products of tallow acid, canola acid, or oleic acids with diethylenetriamine in a molecular ratio of about 2:1, said reaction product mixture containing N,N″-ditallowoyldiethylenetriamine, N,N″-dicanolaoyldiethylenetriamine, or N,N″-dioleoyldiethylenetriamine, respectively, with the formula:
R¹—C(O)—NH—CH₂CH₂—NH—CH₂CH₂—NH—C(O)—R¹
wherein R² and R³ are divalent ethylene groups, R¹ is defined above and an acceptable examples of this structure when R¹ is the oleoyl group of a commercially available oleic acid derived from a vegetable or animal source, include Emersol® 223LL or Emersol® 7021, available from Henkel Corporation.

Another fabric softening active for use in the present compositions has the formula:
[R¹—C(O)—NR—R²—N(R)₂—R³—NR—C(O)—R¹]⁺X⁻
wherein R, R¹, R², R³ and X⁻ are defined as above. Examples of this fabric softening active are the di-fatty amidoamines based softener having the formula:
[R¹—C(O)—NH—CH₂CH₂—N(CH₃)(CH₂CH₂OH)—CH₂CH₂—NH—C(O)—R¹]⁺CH₃SO₄⁻
wherein R¹—C(O) is an oleoyl group, soft tallow group, or a hardened tallow group available commercially from Degussa under the trade names Varisoft® 222LT, Varisoft® 222, and Varisoft® 110, respectively.

A second type of DEQA (“DEQA (2)”) compound suitable as a fabric softening active in the present compositions has the general formula:
[R₃N⁺CH₂CH(YR¹)(CH₂YR¹)]X⁻
wherein each Y, R, R¹, and X⁻ have the same meanings as before. Such compounds include those having the formula:
[CH₃]₃ N⁽⁺⁾[CH₂CH(CH₂O(O)CR¹)O(O)CR¹]Cl⁽⁻⁾
wherein each R is a methyl or ethyl group and preferably each R¹ is in the range of C₁₅ to C₁₉. As used herein, when the diester is specified, it can include the monoester that is present. The amount of monoester that can be present is the same as in DEQA (1).

These types of agents and general methods of making them are disclosed in U.S. Pat. No. 4,137,180, Naik et al., issued Jan. 30, 1979. An example of a preferred DEQA (2) is the “propyl” ester quaternary ammonium fabric softener active having the formula 1,2-di(acyloxy)-3-trimethylammoniopropane chloride.

The present invention is based on the surprising discovery that optimizing a quaternary ammonium compound suitable as fabric softener active based on a select range of parameters that includes (1) monoester/diester ratio, and (2) degree of saturation (i.e., double bonds) per the IV value; facilitate obtaining compositions with a high level of the quaternary compound. Moreover, quaternary compounds meeting these parameters allow a broader range of solvents that include cost-effective solvents, such as but not limited to glycol ethers, which are particularly important when distributing fabric softening products in developing markets that are currently cost-prohibitive. Further, glycol ethers provided the added benefits of a high flash point and act as a dual solvent for quaternization and final end product solvent.

It is acceptable for the present invention for the fabric softener active to have an IV from about 0 to about 140. However, another aspect of the invention provides a quaternary ammonium compound suitable as a fabric softener active comprising an IV of from about IV about 1 to about 70, preferably about 1 to about 60, more preferably about 1 to about 40, even more preferably 1 to about 10. Without wishing to be bound by theory, a low IV value of the defined range provides very efficient softness but not good solubility. In order to have the best softness performance but also make a concentrate composition, the monoester content is increased to enable solubility of the low IV quaternary ammonium compound. One aspect of the invention provides a quaternary ammonium compound suitable as a fabric softener active comprising from 15% monoester and 85% diester by total weight of the quaternary ammonium compound to 40% monoester to 60% diester by total weight of the quaternary ammonium compound. Without wishing to be bound by theory, increasing the monoester content (relative to the diester content) of the quaternary ammonium compound increases the solubility of the compound in water as well as a broad range of solvents. However, too high a level of monoester content of the quaternary compound provides a compound does not provide enough softening efficiency. In turn, too high of a diester content provides a compound that although provides high fabric softening efficiency, lacks the soluability properties to provide a concentrate. Thus, the present invention is based, in part, upon the surprising discovery of an optimal balance of a monoester to diester ratio.

In one embodiment, the composition of the present invention is clear or translucent. When the concentrated fabric softening composition is diluted to form a fabric care composition that is clear or translucent, the concentrated fabric softening composition preferably comprises highly fluid fabric softening actives with transition temperatures less than about 35° C. These materials can be made with fatty acid precursors having high IV (greater than about 50) or comprising branching or other structural modifications leading to a low transition temperature. Additionally when the concentrated FSA composition is used to form a clear fabric care composition, the unsaturated fabric softener actives that are preferred for the said concentrated composition comprise an unsaturated moiety that preferably has a cis:trans isomer ratio of at least 1:1, preferably about 2:1, more preferably about 3:1, and even more preferably 4:1 or higher. Some preferred actives for clear compositions are disclosed in U.S. Pat. No. 6,369,025; U.S. application Ser. No. 09/554,969, filed Nov. 24, 1998 by Frankenbach et al. (WO 99/27050); and U.S. Pat. No. 6,486,121.

When the concentrated fabric softening composition is diluted to form a fabric care composition that comprises dispersed lamellar particles, the concentrated fabric softening composition preferably comprises fabric softening actives with low fluidity and transition temperatures greater than about 30° C.

While it is acceptable for the present invention for the composition to contain a number of softening actives, including other fabric softening actives disclosed herein below, the DEQA fabric softening actives, and specifically those fabric softener actives with two ester linkages, are preferred fabric softening actives for the present invention.

Other Fabric Softening Actives

Instead of, or in addition to, the DEQA fabric softening actives described hereinbefore, the present compositions can also comprise a variety of other fabric softening actives. These other suitable fabric softening actives include:

(1) compounds having the formula:
[R₄₋ₘ—N⁽⁺⁾—R¹ₘ]A⁻
wherein each m is 2 or 3, each R¹ is a C₆-C₂₂, preferably C₁₄-C₂₀, but no more than one being less than about C₁₂ and then the other is at least about 16, hydrocarbyl, or substituted hydrocarbyl substituent, preferably C₁₀-C₂₀ alkyl or alkenyl (unsaturated alkyl, including polyunsaturated alkyl, also referred to sometimes as “alkylene”), most preferably C₁₂-C₁₈ alkyl or alkenyl, and branch or unbranced. While it is acceptable for the IV of the parent fatty acid containing the R¹ group to range from zero to about 140, it is preferred for the present invention to have an IV of at least about 40. When the fabric softener composition will be clear, it is preferred for fabric softner active to be highly fluid by incorporating branching in the hydrocarbyl group by incorporating high unsaturation e.g. the IV of a fatty acid containing this R¹ group is from about 70 to about 140, more preferably from about 80 to about 130; and most preferably from about 90 to about 115 (as used herein, the term “Iodine Value” means the Iodine Value of a “parent” fatty acid, or “corresponding” fatty acid, which is used to define a level of unsaturation for an R¹ group that is the same as the level of unsaturation that would be present in a fatty acid containing the same R¹ group) with, preferably, a cis/trans ratio as specified above for highly unsaturated compounds; each R is H or a short chain C₁-C₆, preferably C₁-C₃ alkyl or hydroxyalkyl group, e.g., methyl (most preferred), ethyl, propyl, hydroxyethyl, and the like, benzyl, or (R²O)₂₋₄H where each R² is a C₁₋₆ alkylene group; and A⁻ is a softener compatible anion, preferably, chloride, bromide, methylsulfate, ethylsulfate, sulfate, phosphate, or nitrate; more preferably chloride or methyl sulfate. Examples of these fabric softening actives include dialkydimethylammonium salts and dialkylenedimethylammonium salts such as ditallowdimethylammonium chloride, dicanoladimethylammonium chloride, and dicanoladimethylammonium methylsulfate. Examples of commercially available dialkylenedimethylammonium salts usable in the present invention are di-hydrogenated tallow dimethyl ammonium chloride, ditallowdimethyl ammonium chloride, and dioleyldimethylammonium chloride available from Degussa under the trade names Adogen® 442, Adogen® 470, and Adogen® 472, respectively.

For fabric softener actives that comprise a mixture of materials having a single hydrocarbyl tail and having two hydrocarbyl tails preferred embodiments are detailed herein. In one preferred embodiment, the content of material with two hydrocarbyl tails comprises from about 60% to about 75% of the total percent of softener active weight. In another preferred embodiment the material with two hydrocarbyl tails comprises from about 75% to 90% of the total percent of softener active weight. Materials from this group preferred for the present invention also include those comprising a low level of material with one hydrocarbyl tails; preferably less than about 40% of the total percent of softener active weight. In a preferred embodiment, the material with one hydrocarbyl tail comprises from about 15% to about 40% of the total percent of softener active weight. In another embodiment, the material with one hydrocarbyl tail more than about 1%, preferably more than about 5%, most preferably about 10% and less that about 15% of the total percent of softener active weight. For a preferred embodiment of the present invention when the concentrated module is used to make a fabric softening composition that is used in conditions where carry-over of anionic surfactant occurs, the mole ratio of the monotail to ditail species is typically 1 to ≦about 1.5, preferably 1 to ≦about 1.4, and most preferably 1 to ≦about 1.3 moles of monotail to moles of ditail species; it is further preferred for this embodiment for the mole ratio of monotail to ditail to be 1 to ≧1 moles of monotail to moles of ditail.

(2) compounds having the formula: 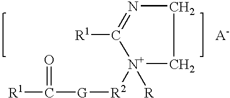
wherein each R, R¹, and A⁻ have the definitions given above; each R² is a C₁₋₆ alkylene group, preferably an ethylene group; and G is an oxygen atom or an —NR— group. Examples of this fabric softening active are 1-methyl-1-tallowylamidoethyl-2-oleylimidazolinium methylsulfate and 1-methyl-1-oleylamidoethyl-2-oleylimidazolinium methylsulfate wherein R¹ is an acyclic aliphatic C₁₅-C₁₇ hydrocarbon group, R² is an ethylene group, G is a NH group, R⁵ is a methyl group and A⁻ is a methyl sulfate anion, available commercially from Degussa under the trade names Varisoft® 475 and Varisoft® 3690, respectively.

(3) compounds having the formula: 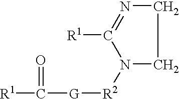
wherein R¹, R² and G are defined as above. An example of this fabric softening active is 1-oleylamidoethyl-2-oleylimidazoline wherein R¹ is an acyclic aliphatic C₁₅-C₁₇ hydrocarbon group, R² is an ethylene group, and G is a NH group.

(4) reaction products of substantially unsaturated and/or branched chain higher fatty acid with hydroxyalkylalkylenediamines in a molecular ratio of about 2:1, said reaction products containing compounds of the formula:
R¹—C(O)—NH—R²—N(R³OH)—C(O)—R¹
wherein R¹, R² and R³ are defined as above. Examples of this fabric softening active are reaction products of fatty acids such as tallow fatty acid, oleic fatty acid, or canola fatty acid with N-2-hydroxyethylethylenediamine in a molecular ratio of about 2:1, said reaction product mixture containing a compound of the formula:
R¹—C(O)—NH—CH₂CH₂—N(CH₂CH₂OH)—C(O)—R¹
wherein R¹—C(O) is oleoyl, tallowyl, or canola-oyl group of a commercially available fatty acid derived from a vegetable or animal source. Nonlimiting examples of such actives include Emersol® 223LL or Emersol® 7021, which are derived from oleic acid and available from Henkel Corporation.

(5) compounds having the formula: 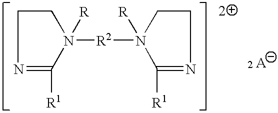
wherein R, R¹, R², and A⁻ are defined as above.

Other compounds suitable as fabric softening actives herein are acyclic quaternary ammonium salts having the formula:
[R¹—N(R⁵)₂—R⁶]⁺A⁻
wherein R⁵ and R⁶ are C₁-C₄ alkyl or hydroxyalkyl groups, and R¹ and A⁻ are defined as herein above. Examples of these fabric softening actives are the monoalkyltrimethylammonium salts and the monoalkenyltrimethylammonium salts such as monotallowyltrimethylammonium chloride, monostearyltrimethylammonium chloride, monooleyltrimethylammonium chloride, and monocanolatrimethylammonium chloride. Commercial examples include tallowtrimetylammonium chloride and soyatrimethylammonium chloride available from Degussa under the trade names Adogen® 471 and Adogen® 415.

(6) substituted imidazolinium salts having the formula: 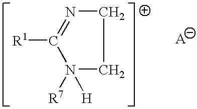
wherein R⁷ is hydrogen or a C₁-C₄ saturated alkyl or hydroxyalkyl group, and R¹ and A⁻ are defined as hereinabove;

(7) substituted imidazolinium salts having the formula: 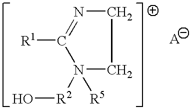
wherein R⁵ is a C₁-C₄ alkyl or hydroxyalkyl group, and R¹, R², and A⁻ are as defined above;

(8) alkylpyridinium salts having the formula: 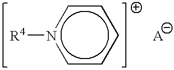
wherein R⁴ is an acyclic aliphatic C₈-C₂₂ hydrocarbon group and A⁻ is an anion. An example of this fabric softening active is 1-ethyl-1-(2-hydroxyethyl)-2-isoheptadecylimidazolinium ethylsulfate wherein R¹ is a C₁₇ hydrocarbon group, R² is an ethylene group, R⁵ is an ethyl group, and A⁻ is an ethylsulfate anion.

(9) alkanamide alkylene pyridinium salts having the formula: 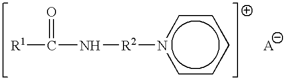
wherein R¹, R² and A⁻ are defined as herein above; and mixtures thereof.

Other suitable fabric softening actives for use in the present compositions include pentaerythritol compounds. Such compounds are disclosed in more detail in, e.g., U.S. Pat. No. 6,492,322 U.S. Pat. No. 6,194,374; U.S. Pat. No. 5,358,647; U.S. Pat. No. 5,332,513; U.S. Pat. No. 5,290,459; U.S. Pat. No. 5,750,990, U.S. Pat. No. 5,830,845 U.S. Pat. No. 5,460,736 and U.S. Pat. No. 5,126,060.

Polyquaternary ammonium compounds can also be useful as fabric softening actives in the present compositions and are described in more detail in the following patent documents: EP 803,498; GB 808,265; GB 1,161,552; DE 4,203,489; EP 221,855; EP 503,155; EP 507,003; EP 803,498; FR 2,523,606; JP 84-273918; JP 2-011,545; U.S. Pat. No. 3,079,436; U.S. Pat. No. 4,418,054; U.S. Pat. No. 4,721,512; U.S. Pat. No. 4,728,337; U.S. Pat. No. 4,906,413; U.S. Pat. No. 5,194,667; U.S. Pat. No. 5,235,082; U.S. Pat. No. 5,670,472; Weirong Miao, Wei Hou, Lie Chen, and Zongshi Li, Studies on Multifunctional Finishing Agents, Riyong Huaxue Gonye, No. 2, pp. 8-10, 1992; Yokagaku, Vol. 41, No. 4 (1992); and Disinfection, Sterilization, and Preservation, 4^{th} Edition, published 1991 by Lea & Febiger, Chapter 13, pp. 226-30. The products formed by quaternization of reaction products of fatty acid with N,N,N′,N′, tetraakis(hydroxyethyl)-1,6-diaminohexane are also suitable for use in the present invention.

Examples of ester and/or amide linked fabric softening actives useful in the present invention, especially for concentrated clear compositions, are disclosed in U.S. Pat. No. 5,759,990 and U.S. Pat. No. 5,747,443. Other fabric softening actives for clear liquid fabric softening compositions are described in U.S. Pat. No. 6,323,172.

Examples of suitable amine softeners that can be used in the present invention as fabric softening actives are disclosed in copending U.S. application Ser. No. 09/463,103, filed Jul. 29, 1997, by Grimm et al., now allowed.

Other fabric softening actives that can be used herein are disclosed, at least generically for the basic structures, in U.S. Pat. No. 3,861,870; U.S. Pat. No. 4,308,151; U.S. Pat. No. 3,886,075; U.S. Pat. No. 4,233,164; U.S. Pat. No. 4,401,578; U.S. Pat. No. 3,974,076; and U.S. Pat. No. 4,237,016. Examples of more biodegradable fabric softeners can be found in U.S. Pat. No. 3,408,361; U.S. Pat. No. 4,709,045; U.S. Pat. No. 4,233,451; U.S. Pat. No. 4,127,489; U.S. Pat. No. 3,689,424; U.S. Pat. No. 4,128,485; U.S. Pat. No. 4,161,604; U.S. Pat. No. 4,189,593; and U.S. Pat. No. 4,339,391.

The fabric softening active in the present compositions is preferably selected from the group consisting of ditallowoyloxyethyl dimethyl ammonium chloride, dihydrogenated-tallowoyloxyethyl dimethyl ammonium chloride, dicanola-oyloxyethyl dimethyl ammonium chloride, ditallow dimethyl ammonium chloride, tritallow methyl ammonium chloride, methyl bis(tallow amidoethyl)₂-hydroxyethyl ammonium methyl sulfate, methyl bis(hydrogenated tallow amidoethyl)-2-hydroxyethyl ammonim methyl sulfate, methyl bis (oleyl amidoethyl)-2-hydroxyethyl ammonium methyl sulfate, ditallowoyloxyethyl dimethyl ammonium methyl sulfate, dihydrogenated-tallowoyloxyethyl dimethyl ammonium chloride, dicanola-oyloxyethyl dimethyl ammonium chloride, N-tallowoyloxyethyl-N-tallowoylaminopropyl methyl amine, 1,2-bis(hardened tallowoyloxy)-3-trimethylammonium propane chloride, and mixtures thereof.

B. Solvent

The composition of the present invention also comprises a solvent or combination of solvents wherein at least one of said solvents has a Clog P from about −2 to about 2. The combinations of solvent for the composition of the present invention are selected such that the said concentrated composition of the present invention has a flash point of above about 38° C., preferably above about 90° C. as measured using the closed cup flash point methodology. Suitable solvents for the present invention when combined with the fabric softener active will generate a concentrated FSA composition of the present invention achieves a liquid state, as measured by a viscosity, as measured on a Brookhaven viscometer, of typically less than 500 cPs, preferably less than 400 cPs, more preferably less than 300 cPs at a temperature of typically ≦about 80° C., preferably ≦about 70° C., more preferably ≦about 40° C., more preferably ≦about 30° C., most preferably at a temperature less than about ≦about 25° C.

Solvents that are acceptable for the present invention are selected from the groups consisting of mono-ols, and polyhydric alcohols including aliphatic and/or alicyclic diols and glycols with a given number of carbon atoms; along with derivatives of diols, glycols, and glycerine; especially, but not limited to alkoxylates of diols, glycols, and glycerine. Solvents comprising ester, ketone, aldehyde, and amine functionality are also acceptable, but less preferred due to the tendency for some of these solvents to have higher odor or hydrolytic and/or oxidative instability.

For the present invention, many solvents are suitable and an extensive non-limiting listing of solvents that are suitable can be found in WO 97/03172 by E. H. Wahl et al. published 30 Jan. 1997 from page 17 line 5 to page 73 line 2. Within WO 97/03172, many solvents are listed as inoperable that are suitable for the present invention because it is now found for the present invention that a wider range of solvents having a Clog P from about −2 to about 2 are suitable for the present invention. All solvents listed in WO 97/01372 from page 17 line 5 to page 73 line 2 are included herein by reference.

Some typical nonlimiting solvents include:

mono-ols: n-propanol; 2-butanol; 2-methyl-2-propanol;

propane diol isomers: 1,2-propanediol; 1,3-propanediol;

butane diol isomers: 1,2-butanediol; 1,3-butanediol; 1,4-butanediol; 2,3-butanediol;

pentane diol isomers: 1,2-pentanediol; 2,4-pentanediol; 1,5-pentanediol; neopentyl glycol;

hexane diol isomers including: 2,3-butanediol, 2,3-dimethyl-; 1,2-butanediol, 2,3-dimethyl-; 1,2-butanediol, 3,3-dimethyl-; 2,3-pentanediol, 2-methyl-; 2,3-pentanediol, 3-methyl-; 2,3-pentanediol, 4-methyl-; 2,3-hexanediol; 3,4-hexanediol; 1,2-butanediol, 2-ethyl-; 1,2-pentanediol, 2-methyl-; 1,2-pentanediol, 3-methyl-; 1,2-pentanediol, 4-methyl-; and/or 1,2-hexanediol; 1,3 hexane diol, 2,5-hexanediol; 2,4-pentanediol, 2-methyl.

heptane diol isomers including: 1,3-propanediol, 2-butyl-; 1,3-propanediol, 2,2-diethyl-; 1,3-propanediol, 2-(1-methylpropyl)-; 1,3-propanediol, 2-(2-methylpropyl)-; 1,3-propanediol, 2-methyl-2-propyl-; 1,2-butanediol, 2,3,3-trimethyl-; 1,4-butanediol, 2-ethyl-2-methyl-; 1,4-butanediol, 2-ethyl-3-methyl-; 1,4-butanediol, 2-propyl-; 1,4-butanediol, 2-isopropyl-; 1,5-pentanediol, 2,2-dimethyl-; 1,5-pentanediol, 2,3-dimethyl-; 1,5-pentanediol, 2,4-dimethyl-; 1,5-pentanediol, 3,3-dimethyl-; 2,3-pentanediol, 2,3-dimethyl-; 2,3-pentanediol, 2,4-dimethyl-; 2,3-pentanediol, 3,4-dimethyl-; 2,3-pentanediol, 4,4-dimethyl-; 3,4-pentanediol, 2,3-dimethyl-; 1,5-pentanediol, 2-ethyl-; 1,6-hexanediol, 2-methyl-; 1,6-hexanediol, 3-methyl-; 2,3-hexanediol, 2-methyl-; 2,3-hexanediol, 3-methyl-; 2,3-hexanediol, 4-methyl-; 2,3-hexanediol, 5-methyl-; 3,4-hexanediol, 2-methyl-; 3,4-hexanediol, 3-methyl-; 1,3-heptanediol; 1,4-heptanediol; 1,5-heptanediol; and/or 1,6-heptanediol;

octane diol isomers; 1,4-butanediol, 3-methyl-2-isopropyl-; 1,3-pentanediol, 2,2,3-trimethyl-; 1,3-pentanediol, 2,2,4-trimethyl-; 1,3-pentanediol, 2,3,4-trimethyl-; 1,3-pentanediol, 2,4,4-trimethyl-; 1,3-pentanediol, 3,4,4-trimethyl-; 1,4-pentanediol, 2,2,3-trimethyl-; 1,4-pentanediol, 2,2,4-trimethyl-; 1,4-pentanediol, 2,3,3-trimethyl-; 1,4-pentanediol, 2,3,4-trimethyl-; 1,4-pentanediol, 3,3,4-trimethyl-; 1,5-pentanediol, 2,2,3-trimethyl-; 1,5-pentanediol, 2,2,4-trimethyl-; 1,5-pentanediol, 2,3,3-trimethyl-; 1,5-pentanediol, 2,3,4-trimethyl-; 2,4-pentanediol, 2,3,3-trimethyl-; 2,4-pentanediol, 2,3,4-trimethyl-; 1,3-pentanediol, 2-ethyl-2-methyl-; 1,3-pentanediol, 2-ethyl-3-methyl-; 1,3-pentanediol, 2-ethyl-4-methyl-; 1,3-pentanediol, 3-ethyl-2-methyl-; 1,4-pentanediol, 2-ethyl-2-methyl-; 1,4-pentanediol, 2-ethyl-3-methyl-; 1,4-pentanediol, 2-ethyl-4-methyl-; 1,4-pentanediol, 3-ethyl-2-methyl-; 1,4-pentanediol, 3-ethyl-3-methyl-; 1,5-pentanediol, 2-ethyl-2-methyl-; 1,5-pentanediol, 2-ethyl-3-methyl-; 1,5-pentanediol, 2-ethyl-4-methyl-; 1,5-pentanediol, 3-ethyl-3-methyl-; 2,4-pentanediol, 3-ethyl-2-methyl-; 1,3-pentanediol, 2-isopropyl-; 1,3-pentanediol, 2-propyl-; 1,4-pentanediol, 2-isopropyl-; 1,4-pentanediol, 2-propyl-; 2 ethyl-1,3-hexane diol.

nonane diol isomers;

glyceryl ethers and/or di(hydroxyalkyl)ethers including: 1,2-propanediol, 3-(n-pentyloxy)-; 1,2-propanediol, 3-(2-pentyloxy)-; 1,2-propanediol, 3-(3-pentyloxy)-; 1,2-propanediol, 3-(2-methyl-1-butyloxy)-; 1,2-propanediol, 3-(iso-amyloxy)-; 1,2-propanediol, 3-(3-methyl-2-butyloxy)-; 1,2-propanediol, 3-(cyclohexyloxy)-; 1,2-propanediol, 3-(1-cyclohex-1-enyloxy)-; 1,3-propanediol, 2-(pentyloxy)-; 1,3-propanediol, 2-(2-pentyloxy)-; 1,3-propanediol, 2-(3-pentyloxy)-; 1,3-propanediol, 2-(2-methyl-1-butyloxy)-; 1,3-propanediol, 2-(iso-amyloxy)-; 1,3-propanediol, 2-(3-methyl-2-butyloxy)-; 1,3-propanediol, 2-(cyclohexyloxy)-; 1,3-propanediol, 2-(1-cyclohex-1-enyloxy)-; 1,2-propanediol, 3-(butyloxy)-, triethoxylated; 1,2-propanediol, 3-(butyloxy)-, tetraethoxylated; 1,2-propanediol, 3-(butyloxy)-, pentaethoxylated; 1,2-propanediol, 3-(butyloxy)-, hexaethoxylated; 1,2-propanediol, 3-(butyloxy)-, heptaethoxylated; 1,2-propanediol, 3-(butyloxy)-, octaethoxylated; 1,2-propanediol, 3-(butyloxy)-, nonaethoxylated; 1,2-propanediol, 3-(butyloxy)-, monopropoxylated; 1,2-propanediol, 3-(butyloxy)-, dibutyleneoxylated; 1,2-propanediol, 3-(butyloxy)-, tributyleneoxylated; 1,2-propanediol, 3-phenyloxy-; 1,2-propanediol, 3-benzyloxy-; 1,2-propanediol, 3-(2-phenylethyloxy)-; 1,2-propanediol, 3-(1-phenyl-2-propanyloxy)-; 1,3-propanediol, 2-phenyloxy-; 1,3-propanediol, 2-(m-cresyloxy)-; 1,3-propanediol, 2-(p-cresyloxy)-; 1,3-propanediol, -benzyloxy-; 1,3-propanediol, 2-(2-phenylethyloxy)-; 1,3-propanediol, 2-(1-phenylethyloxy)-; bis(2-hydroxybutyl)ether; and/or bis(2-hydroxycyclopentyl)ether;

glycol ethers: dipropylene glycol methyl ether (DOWANOL® DPM) dipropylene glycol methyl ether acetate (DOWANOL® DPMA); polylene glycol n-butyl ether (DOWANOL® PnB), (PROGLYDE® DMM); ethylene glycol hexyl ether (hexyl CELLOSOLVE®), ethylene glycol n-butyl ether acetate (butyl CELLOSOLVE® acetate); ethylene glycol phenyl ether (DOWANOL® Eph).

Unsaturated solvents, cyclic, and aromatic solvents such as 2-butene-1,4-diol; 2-butyne-1,4-diol; 3,6-dimethy-4-octyne-3,6-diol, p-xylenene glycol; 1-phenyl-1,2-ethanediol; 1-phenyl-1,2-propanediol; 2-phenyl-1,2-propanediol; 3-phenyl-1,2-propanediol; 1-(3-methylphenyl)-1,3-propanediol; 1-(4-methylphenyl)-1,3-propanediol; 2-methyl-1-phenyl-1,3-propanediol; 1-phenyl-1,3-butanediol; 3-phenyl-1,3-butanediol; 1-phenyl-1,4-butanediol; 2-phenyl-1,4-butanediol; and/or 1-phenyl-2,3-butanediol; are also acceptable for the present invention.

mixtures thereof;

C. Optional Ingredients

It is preferred for the concentrated fabric softening composition of the present invention to comprise minimal optional ingredients such that the said concentrated composition of the present invention is utilized to form a base fabric care composition that can be easily differentiated by adding additional materials after the fabric care composition is formed.

It may occasionally be useful for the present invention to have one or more optional ingredients included in the concentrated fabric softening active composition. For instance when there are only one or two products marketed in a geography, it may be desirable to include optional ingredients like perfume to decrease the need to store additional components at the site where the fabric care composition will be generated by dilution of the said concentrated composition. It may also be useful to incorporate additional adjunct fabric softening actives, when such actives are desired in the fabric care composition generated by dilution of the said concentrated composition. It may further be useful, for formation of a stable concentrated fabric softening active composition to include a bilayer stabilizer or salts. The bilayer stabilizer and the salt may also add in dilution of the concentrated fabric softening composition to the said fabric care composition.

While the said optional ingredients are indeed optional for the formation of the concentrated FSA composition of the present invention, some elements are essential for the formation of a dilute fabric softening composition such as perfume.

1. Adjunct Fabric Softening Actives.

Cationic Starch Compounds

One example of a fabric softening active is a cationic starch compound. The term “cationic starch” is used herein in the broadest sense. In one aspect of the invention, cationic starch refers to starch that has been chemically modified to provide the starch with a net positive charge in aqueous solution at pH 3. This chemical modification includes, but is not limited to, the addition of amino and/or ammonium group(s) into the starch molecules. Non-limiting examples of these ammonium groups may include substituents such as trimethylhydroxypropyl ammonium chloride, dimethylstearylhydroxypropyl ammonium chloride, or dimethyldodecylhydroxypropyl ammonium chloride. See Solarek, D. B., Cationic Starches in Modified Starches: Properties and Uses, Wurzburg, O. B., Ed., CRC Press, Inc., Boca Raton, Fla. 1986, pp 113-125. Suitable cationic starch compounds are described in U.S. patent application Ser. No. 10/78984, filed Mar. 25, 2004.

In the present invention cationic starch is included in the concentrated composition at a level of at least 1% and preferably less than about 20%, preferably less than about 10% of the weight of the said concentrated composition. In the fabric softening composition of the present invention, the cationic starch is included at a level of at least about 0.1%, preferably at least about 0.5% and less than or equal to about 5% of the weight of the said fabric care composition.

The source of starch before chemical modification can be chosen from a variety of sources including tubers, legumes, cereal, and grains. Non-limiting examples of this source starch may include corn starch, wheat starch, rice starch, waxy corn starch, oat starch, cassava starch, waxy barley, waxy rice starch, glutenous rice starch, sweet rice starch, amioca, potato starch, tapioca starch, oat starch, sago starch, sweet rice, or mixtures thereof.

In one embodiment of the invention, cationic starch for use in the present compositions is chosen from cationic maize starch, cationic tapioca, cationic potato starch, or mixtures thereof. In another embodiment, cationic starch is cationic maize starch.

The cationic starch in the present invention may compromise one or more additional modifications. For example, these modifications may include cross-linking, stabilization reactions, phophorylations, hydrolyzations, cross-linking. Stabilization reactions may include alkylation and esterification.

Cationic starch of the present invention may comprise a maltodextrin. In one embodiment, cationic starch of the present invention may comprise a Dextrose Equivalance (“DE”) value of from about 0 to about 35. The Dextrose Equivalence value is a measure of the reducing equivalence of the hydrolyzed starch referenced to dextrose and expressed as a percent (on dry basis). One skilled in the art will readily appreciate that a completely hydrolyzed starch to dextrose has a DE value of 100, while unhydrolyzed starch has a DE of 0. In one embodiment of the invention, the cationic starch of the present invention comprises maltodextrin and comprises a DE value of from about 0 to about 35, preferably of from about 5 to about 35. A suitable assay for DE value includes one described in “Dextrose Equivalent,” Standard Analytical Methods of the Member Companies of the Corn Industries Research Foundation. 1Ed., Method E-26. Cationic starch of the present invention may comprise a dextrin. One skilled in the art will readily appreciate that dextrin is typically a pyrolysis product of starch with a wide range of molecular weights.

In one embodiment of the present invention, the cationic starch of the present invention may comprise a particular degree of substitution. As used herein, the “degree of substitution” of cationic starches is an average measure of the number of hydroxyl groups on each anhydroglucose unit which are derivitised by substituent groups. Since each anhydroglucose unit has three potential hydroxyl groups available for substitution, the maximum possible degree of substitution is 3. The degree of substitution is expressed as the number of moles of substituent groups per mole of anhydroglucose unit, on a molar average basis. The degree of substitution can be determined using proton nuclear magnetic resonance spectroscopy (“¹H NMR”) methods well-known in the art. Suitable ¹H NMR techniques include those described in “Observation on NMR Spectra of Starches in Dimethyl Sulfoxide, Iodine-Complexing, and Solvating in Water-Dimethyl Sulfoxide”, Qin-Ji Peng and Arthur S. Perlin, Carbohydrate Research, 160 (1987), 57-72; and “An Approach to the Structural Analysis of Oligosaccharides by NMR Spectroscopy”, J. Howard Bradbury and J. Grant Collins, Carbohydrate Research, 71, (1979), 15-25. In one embodiment of the invention, the cationic starch comprises a degree of substitution of from about 0.01 to about 2.5, preferably from about 0.01 to about 1.5, and more preferably from about 0.025 to about 0.5. In another embodiment of the invention, when the cationic starch comprises cationic maize starch, said cationic starch preferably comprises a degree of substitution of from about 0.04 to about 0.06. In still another embodiment of the invention, when the cationic starch comprises a hydrolyzed cationic starch, said cationic starch comprises a degree of substitution of from about 0.02 to about 0.06.

One skilled in the art will readily appreciate that starch, particularly native starch, comprises polymers made of glucose units. There are two distinct polymer types. One type of polymer is amylose whereas the other is amylopectin. The cationic starch of the present invention may be further characterized with respect to these types of polymers. In one embodiment, the cationic starch of the present invention comprises amylose at a level of from about 0% to about 70%, preferably from about 10% to about 60%, and more preferably from about 15% to about 50%, by weight of the cationic starch. In another embodiment, when the cationic starch comprises cationic maize starch, said cationic starch preferably comprises from about 25% to about 30% amylose, by weight of the cationic starch. The remaining polymer in the above embodiments essentially comprises amylopectin.

A suitable techniques for measuring percentage amylose by weight of the cationic include the methods described by the following: “Determination of Amylose in Cereal and Non-Cereal Starches by a Colorimetric Assay: Collaborative Study”, Christina Martinez and Jaques Prodolliet, Starch, 48 (1996), pp. 81-85; and “An Improved Colorimetric Procedure for Determining Apparent and Total Amylose in Cereal and Other Starches”, William R. Morrison and Bernard Laignelet, Journal Of Cereal Science, 1 (1983).

The cationic starches of the present invention may comprise amylose and/or amylopectin (hereinafter “starch components”) at a particular molecular weight range. In one embodiment of the invention, the cationic starch comprises starch components, wherein said starch components comprise a molecular weight range at preferably from about 50,000 to about 10,000,000; more preferably from about 150,000 to about 7,000,000, more preferably from about 250,000 to about 4,000,000, and even more preferably from about 400,000 to about 3,000,000. In another embodiment, the molecular weight of said starch component is from about 250,000 to about 2,000,000. As used herein, the term “molecular weight of starch component” refers to the weight average molecular weight. This weight average molecular weight may be measured according to a gel permeation chromatography (“GPC”) method described in U.S. Publication No. 2003/0154883 A1, entitled “Non-Thermoplastic Starch Fibers and Starch Composition for Making Same.”

In one embodiment of the invention, the cationic starch of the present invention is hydrolyzed to reduce the molecular weight of such starch components. The degree of hydrolysis may be measured by Water Fluidity (WF), which is a measure of the solution viscosity of the gelatinized starch. A suitable method for determining WF is described at columns 8-9 of U.S. Pat. No. 4,499,116. One skilled in the art will readily appreciate that cationic starch that has a relatively high degree of hydrolysis will have low solution viscosity or a high water fluidity value. One embodiment of the invention comprises, a cationic starch comprises a viscosity measured as WF having a value from about 50 to about 84, preferably 65 to about 84, more preferable 70 to about 84. A suitable method of hydrolyzing starch includes one described by U.S. Pat. No. 4,499,116, with specific mention to column 4. In one embodiment, the cationic starch of the present invention comprises a viscosity measured by Water Fluidity having a value from about 50 to about 84.

The cationic starch in present invention may be incorporated into the composition in the form of intact starch granules, partially gelatinized starch, pregelatinized starch, cold water swelling starch, hydrolyzed starch (e.g., acid, enzyme, alkaline degradation), or oxidized starch (e.g., peroxide, peracid, alkaline, or any other oxidizing agent). Fully gelatinized starches may also be used, but at lower levels (e.g., about from about 0.5% to about 8% of the weight of the concentrated fabric softening active composition and from about 0.1% to about 0.8% by weight of the fabric softening composition) to prevent fabric stiffness and limit viscosity increases. Fully gelatinized starches may be used at the higher levels (e.g., 0.5% to about 5% by weight of the cationic starch) when the molecular weight of the starch material has been reduced by hydrolysis.

Suitable cationic starches for use in the present compositions are commercially-available from Cerestar under the trade name C*BOND® and from National Starch and Chemical Company under the trade name CATO® 2A.

Silicones

In one embodiment of the invention, the fabric care composition comprises a silicone as a fabric care active. Silicones can be used to impart a lubricating property, or increased gliding ability, to fibers in fabric, particularly clothing. Non-limiting examples of useful silicones in the composition of the present invention include noncurable silicones such as polydimethylsilicone, non-curable aminofunctional silicones, volatile silicones, and curable silicones such as aminosilicones, phenylsilicones, hydroxysilicones, and silicone polyethers. The word “silicone” as used herein preferably refers to emulsified silicones, including those that are commercially available and those that are emulsified in the composition, unless otherwise described. Preferably, the silicones are hydrophobic; are neither irritating, toxic, nor otherwise harmful when applied to fabric or when they come in contact with human skin; are chemically stable under normal use and storage conditions; and are capable of being deposited on fabric.

Many types of aminofunctional silicones also cause fabric yellowing. Thus, the silicones that cause fabric discoloration are also not preferred.

In one embodiment, the silicones are polydimethyl siloxanes; more preferred silicones are polydimethyl siloxanes having a viscosity of from about 50 to about 1,000,000 centistokes at 25° C.

Other useful silicone materials include materials of the formula:
HO—[Si(CH₃)₂—O]ₓ—{Si(OH)[(CH₂)₃—NH—(CH₂)₂—NH₂]O}_{y}—H
wherein x and y are integers which depend on the molecular weight of the silicone, preferably having a viscosity of from about 1,000 cst to about 500,000 cst at 25° C. This material is also known as “amodimethicone”. Although silicones with a high number, e.g., greater than about 0.5 millimolar equivalent of amine groups can be used, they are not preferred because they can cause fabric yellowing.

Similarly, silicone materials which can be used correspond to the formulas:
(R¹)ₐG₃₋ₐ—Si—(—OSiG₂)ₙ—(OSiG_{b}(R¹)_{2-b})ₘ—O—SiG₃₋ₐ(R¹)ₐ
wherein G is selected from the group consisting of hydrogen, phenyl, OH, and/or C₁-C₈ alkyl; a denotes 0 or an integer from 1 to 3; b denotes 0 or 1; the sum of n+m is a number from 1 to about 2,000; R¹ is a monovalent radical of formula CₚH₂ₚL in which p is an integer from 2 to 8 and L is selected from the group consisting of:
—N(R²)CH₂—CH₂—N(R²)₂;
—N(R²)₂;
—N⁺(R²)₃A⁻; and
—N⁺(R²)CH₂—CH₂N⁺H₂A⁻
wherein each R² is chosen from the group consisting of hydrogen, phenyl, benzyl, saturated hydrocarbon radical, and each A⁻ denotes compatible anion, e.g., a halide ion; and
R³—N⁺(CH₃)₂-Z-[Si(CH₃)₂O]_{f}—Si(CH₃)₂-Z-N⁺(CH₃)₂—R³.2CH₃COO⁻
wherein

Z=—CH₂—CH(OH)—CH₂O—CH₂)₃—

R³ denotes a long chain alkyl group; and

f denotes an integer of at least about 2.

In the formulas herein, each definition is applied individually and averages are included.

Another silicone material which can be used, but is less preferred than polydimethyl siloxanes, has the formula:
(CH₃)₃Si—[O—Si(CH₃)₂]ₙ—{OSi(CH₃)[(CH₂)₃—NH—(CH₂)₂—NH₂]}ₘ—OSi(CH₃)₃
wherein n and m are the same as before. The preferred silicones of this type are those which do not cause fabric discoloration.

Alternatively, the silicone material can be provided as a moiety or a part of an oligosaccharide molecule. These materials provide a lubricity benefit in addition to the expected fabric care benefits. Other examples of dual function silicone materials useful in the present invention are shape retention copolymers having siloxane macromers grafted thereto. The non-silicone backbone of such polymers should have a molecular weight of from about 5,000 to about 1,000,000, and the polymer should have a glass transition temperature (Tg), i.e., the temperature at which the polymer changes from a brittle vitreous state to a plastic state, of greater than about −20° C. Shape retention silicone-containing polymers useful in the present invention are described in more detailed herein below along with other shape retention polymers.

When silicone is present, it is present at least an effective amount to provide lubrication of the fibers, typically from about 0.1% to about 10%, preferably from about 0.2% to about 5%, more preferably from about 0.3% to about 3%, by weight of the usage composition.

In another embodiment, the silicone can be either a polydimethyl siloxane (polydimethyl silicone or PDMS), or a derivative thereof, e.g., amino silicones, ethoxylated silicones, etc. The PDMS, is one having a viscosity of from about 2 to about 1,000,000 cSt, preferably from about 5 to about 1,000,000 cSt, more preferably from about 100 to about 500,000 cSt., and even more preferably from about 5000 to 330,000 cSt.

Silicone derivatives such as amino-functional silicones, quaternized silicones, and silicone derivatives containing Si—OH, Si—H, and/or Si—Cl bonds, can be used. However, these silicone derivatives are normally more substantive to fabrics and can build up on fabrics after repeated treatments to actually cause a reduction in fabric absorbency.

The amount of PDMS needed to provide a noticeable improvement in water absorbency is dependent on the initial rewettability performance, which, in turn, is dependent on the detergent type used in the wash. Effective amounts range from about 2 ppm to about 50 ppm in the rinse water, preferably from about 5 to about 20 ppm. The PDMS to softening active ratio is from about 2:100 to about 50:100, preferably from about 3:100 to about 35:100, more preferably from about 4:100 to about 25:100. This typically requires from about 0.2% to about 20%, preferably from about 0.5% to about 10%, more preferably from about 1% to about 5% silicone.

Clays

Clay minerals used to provide the softening properties of the present compositions can be described as expandable, three-layer clays, i.e., alumino-silicates and magnesium silicates, having an ion exchange capacity of at least 50 meq/100 g. of clay. The term “expandable” as used to describe clays relates to the ability of the layered clay structure to be swollen, or expanded, on contact with water. The three-layer expandable clays used herein are those materials classified geologically as smectites.

Both classes of smectite-type clays; those comprising within the silicate crystal lattice either aluminum oxide (dioctahedral crystal lattice) or magnesium oxide (trioctahedral crystal lattice). The general formulas of these smectites are Al₂(Si₂O₅)₂(OH)₂ and Mg₃(Si₂O₅)(OH)₂ respectively with the range of the water of hydration in the above formulas varying with the process conditions to which the clay is exposed. Those skilled in the art will understand that suitable clay may comprise substitution by iron and magnesium can occur within the crystal lattice of the smectites, while metal cations such as Na+, Ca++, as well as H+, can be co-present in the water of hydration to provide electrical neutrality.

However it is customary to distinguish between clays on the basis of one cation predominantly or exclusively absorbed. Such absorbed cations can become involved in exchange reactions with cations present in aqueous solutions typically expressed by the following equation: smectite clay (Na)+NH₄OH→smectite clay (NH₄)+NaOH. The cation exchange capacity of clays can be measured in several ways, including by electrodialysis, by exchange with ammonium ion followed by titration or by a methylene blue procedure, all as fully set forth in Grimshaw, “The Chemistry and Physics of Clays”, pp. 264-265, Interscience (1971).

Clays have different cation exchange capacities lower portion of the range. Clays with low cation exchange, i.e., around 26 meq/100 g., such as illite and kalonite clays are preferably not used in the compositions of the present invention. Smectite clays which have a high ion exchange capacity of around 70 meq/100 g., such as, such as nontonite (about 70 meq/100 g) or montmorillonite (>70 meq/100 g), are suitable for the compositions of the present invention. Not to be bound by theory, but clays with a high exchange capacity are expandable clays that tend to deposit on the fabrics to provide the desired softening benefits. Accordingly, clay minerals useful herein can be characterised as expandable, three-layer smectite-type clays having an ion exchange capacity of at least about 50 meq/100 g.

Some examples of the commercially available smectite clays suitable for the present invention include, for example, montmorillonite, volchonskoite, nontronite, hectorite, saponite, sauconite, and vermiculite. The clays herein are available under various tradenames, for example, Thixogel #1® and Gelwhite GP® from Georgia Kaolin Co., Elizabeth, N.J.; Volclay BC® and Volclay #325®, from American Colloid Co., Skokie, Ill.; Black Hills Bentonite BH450®, from International Minerals and Chemicals; and Veegum Pro and Veegum F, from R. T. Vanderbilt. It is to be recognised that such smectite-type minerals obtained under the foregoing tradenames can comprise mixtures of the various discrete mineral entities. Such mixtures of the smectite minerals are suitable for use herein. Clays with less coloration, such as Gelwhite GP®, an extremely white form of smectite clay and are preferred when deposition of the clay on fabric is discernable or formulation of the clay in the composition is discernable

Clays disclosed in U.S. Pat. Appl. Publ. US 20030216274 A1, to Valerio Del Duca, et al., published Nov. 20, 2003 are suitable for the present invention and included herein by reference.

Smectite clays are disclosed in the U.S. Pat. Nos. 3,862,058, 3,948,790, 3,954,632 and 4,062,647. European Patents No.s EP-A-299,575 and EP-A-313,146 in the name of the Procter and Gamble Company describe suitable organic polymeric clay flocculating agents.

2. Perfume

As used herein, perfume includes fragrant substance or mixture of substances including natural (i.e., obtained by extraction of flowers, herbs, leaves, roots, barks, wood, blossoms or plants), artificial (i.e., a mixture of different nature oils or oil constituents) and synthetic (i.e., synthetically produced) odoriferous substances. Such materials are often accompanied by auxiliary materials, such as fixatives, extenders, stabilizers and solvents. These auxiliaries are also included within the meaning of “perfume”, as used herein. Typically, perfumes are complex mixtures of a plurality of organic compounds.

Perfume ingredients may also be suitably added as releasable fragrances, for example, as pro-perfumes or pro-fragrances as described in U.S. Pat. No. 5,652,205 Hartman et al., issued Jul. 29, 1997 incorporated herein by reference.

When optional perfume is used in the concentrated FSA composition of the present invention it is included at a level of less than about 50%, preferably less than about 30%, and more preferably less than about 20% of the weight of the said concentrated composition.

When perfume is not introduced via the concentrated FSA composition of the present invention, it can be introduced into the base product generated by dilution of the said concentrated composition. Perfume is included in the fabric softening composition at a level of at least 0.1%, preferably at least 0.3%, more preferably at least 0.5%, more preferably at least about 1%, and less than about 10%, preferably less than about 5% by weight of the fabric softening composition of the present invention.

3. Bilayer Stabilizer

The present compositions can optionally further comprise a bilayer stabilizer in the form of a nonionic surfactant. The nonionic surfactant is preferably an alkoxylated nonionic surfactant, especially an ethoxylated nonionic surfactant. Suitable nonionic surfactants further include nonionic surfactants derived from saturated and/or unsaturated primary, secondary, and/or branched, amine, amide, amine-oxide fatty alcohol, fatty acid, alkyl phenol, and/or alkyl aryl carboxylic acid compounds, each preferably having from about 6 to about 22, more preferably from about 8 to about 18, carbon atoms in a hydrophobic chain, more preferably an alkyl or alkylene chain, wherein at least one active hydrogen of said compounds is ethoxylated with ≦50, preferably ≦30, more preferably from about 5 to about 15, and even more preferably from about 8 to about 12, ethylene oxide moieties to provide an HLB of from about 8 to about 20, preferably from about 10 to about 18, and more preferably from about 11 to about 15. Suitable nonionic surfactants are described in more detail in U.S. Pat. No. 6,514,931 at col. 8, lines 1-24; U.S. Pat. No. 6,492,322; and U.S. application Ser. No. 09/554,969, filed Nov. 24, 1998 by Frankenbach et al. (WO 99/27050). When present, nonionic surfactants are typically present in the compositions at a level of from about 0.01% to about 5%, preferably from about 0.05% to about 3%, and more preferably from about 0.1% to about 2%, by weight of the composition. Suitable nonionic surfactants include those commercially-available from Shell Chemicals under the trade name NEODOL® 91-8 and from BASF under the trade name PLURONIC® L35.

When a bilayer stabilizer is included in the concentrated FSA composition of the present invention it is included at a level of at least about 1%, preferably at least about 5%, more preferably at least about 10% and less than about 35% of the weight of the said concentrated composition.

When a bilayer stabilizer is included in the fabric softening composition of the present invention, it is included at a level of at least about 0.3%, preferably at least about 0.5%, and less than about 5% by weight of the said fabric softening composition.

4. Aqueous Carrier

The present concentrated fabric softening active compositions optionally comprise an aqueous carrier comprising water. The level of aqueous carrier generally constitutes the balance of the present compositions. When an aqueous carrier is included in the composition comprising a DEQA fabric softening active, it is preferred to use a agent to adjust the pH such that the said concentrated composition has a pH that is 2 to about 5, preferably from about 2 to about 4.5, and more preferably from about 2.5 to about 4.

When an aqueous carrier is included in the concentrated FSA composition of the present invention it is included at a level of at least about 5%, preferably at least about 5%, more preferably at least about 10% and less than about 35% of the weight of the said concentrated composition.

An aqueous carrier is an essential ingredient of the fabric softening composition of the present invention. The aqueous carrier provides the balance of the fabric softening compositions of the present invention. When a DEQA fabric softening active is used in the fabric softening compositions of the present invention it is preferred to use an agent to adjust the pH of the said fabric softening composition such that the pH is 2 to about 5, preferably from about 2 to about 4.5, and more preferably from about 2.5 to about 4.

5. Electrolyte

In one embodiment, the composition of the present invention may comprise an electrolyte. Electrolytes may be organic or inorganic compounds. Electrolytes are useful for both aiding in the formation of dispersed lamellar phase on dilution and for preventing dilution through high viscosity phases. Suitable inorganic electrolytes for the present invention include but are not limited to salts comprising sodium, potassium, magnesium, calcium, aluminum, lithium, and combinations thereof. Salts incorporating cations from groups IIIa, IVa, Va, VIa, VIIa, VIII, Ib, and IIb on the periodic chart with atomic numbers >13 are also useful in reducing dilution viscosity but less preferred due to their tendency to change oxidation states and thus they can adversely affect the odor or color of the formulation or lower weight efficiency. Salts with cations from group Ia or IIa with atomic numbers >20 as well as salts with cations from the lactinide or actinide series are useful in reducing dilution viscosity, but less preferred due to lower weight efficiency or toxicity. Mixtures of above salts are also useful.

Organic salts useful in this invention include, magnesium, sodium, lithium, potassium, zinc, and aluminum salts of the carboxylic acids including formate, acetate, proprionate, pelargonate, citrate, gluconate, lactate aromatic acids e.g. benzoates, phenolate and substituted benzoates or phenolates, such as phenolate, salicylate, polyaromatic acids terephthalates, and polyacids e.g. oxylate, adipate, succinate, benzenedicarboxylate, benzenetricarboxylate. Other useful organic salts include carbonate and/or hydrogencarbonate (HCO₃⁻¹) when the pH is suitable, alkyl and aromatic sulfates and sulfonates e.g. sodium methyl sulfate, benzene sulfonates and derivatives such as xylene sulfonate, and amino acids when the pH is suitable. Electrolytes can comprise mixed salts of the above, salts neutralized with mixed cations such as potassium/sodium tartrate, partially neutralized salts such as sodium hydrogen tartrate or potassium hydrogen phthalate, and salts comprising one cation with mixed anions.

Generally, inorganic electrolytes are preferred over organic electrolytes for better weight efficiency and lower costs. Mixtures of inorganic and organic salts can be used.

When an electrolyte is included in the concentrated fabric softening active composition of the present invention it is included at a level of at least about 0.2%, and less than about 7% of the weight of the said concentrated composition.

When an is included in the fabric softening composition of the present invention, it is included at a level of at least about 0.02%, preferably at least about 0.05%, and less than about 2% by weight of the said fabric softening composition.

6. Cationic Polymers

In one embodiment of the invention, the composition comprises a cationic polymer. Cationic polymers suitable for the present invention include those having a molecular weight of from about 500 to about 1,000,000, preferably from about 1,000 to about 500,000, more preferably from about 1,000 to about 250,000, and even more preferably from about 2,000 to about 100,000 and a charge density of at least about 0.01 meq/gm., preferably from about 0.1 to about 8 meq/gm., more preferably from about 0.5 to about 7, and even more preferably from about 2 to about 6.

The cationic polymers of the present invention can be amine salts or quaternary ammonium salts. Preferred are quaternary ammonium salts. They include cationic derivatives of natural polymers such as some polysaccharide, gums, starch and certain cationic synthetic polymers such as polymers and copolymers of cationic vinyl pyridine or vinyl pyridinium halides. Preferably the polymers are water-soluble, for instance to the extent of at least 0.5% by weight at 20° C. Preferably they have molecular weights of from about 600 to about 1,000,000, more preferably from about 600 to about 500,000, even more preferably from about 800 to about 300,000, and especially from about 1000 to 10,000. As a general rule, the lower the molecular weight the higher the degree of substitution (D.S.) by cationic, usually quaternary groups, which is desirable, or, correspondingly, the lower the degree of substitution the higher the molecular weight which is desirable, but no precise relationship appears to exist. In general, the cationic polymers should have a charge density of at least about 0.01 meq/gm., preferably from about 0.1 to about 8 meq/gm., more preferably from about 0.5 to about 7, and even more preferably from about 2 to about 6.

Suitable desirable cationic polymers are disclosed in U.S. Pat. No. 6,492,322 B1 by Megan A. Cooper, et al. granted 10 Dec. 2002 from column 6 line 65 to colum 23 line 67 and these are included herein by reference. The non-limiting list of the cationic polymers suitable for the present invention includes the following:

In one embodiment, the cationic polymer comprises a polysaccharide gum. Of the polysaccharide gums, guar and locust bean gums, which are galactomannam gums are available commercially, and are preferred. In another embodiment, the cationic polymer comprises cationic guar gum. Guar gums are marketed under Trade Names CSAA M/200, CSA 200/50 by Meyhall and Stein-Hall, and hydroxyalkylated guar gums are available from the same suppliers. Other polysaccharide gums commercially available include: Xanthan Gum; Ghatti Gum; Tamarind Gum; Gum Arabic; and Agar.

Cationic guar gums and methods for making them are disclosed in British Pat. No. 1,136,842 and U.S. Pat. No. 4,031,307. Preferably they have a D.S. of from 0.1 to about 0.5.

An effective cationic guar gum is Jaguar C-13S (Trade Name—Meyhall). Cationic guar gums are a highly preferred group of cationic polymers in compositions according to the invention and act both as scavengers for residual anionic surfactant and also add to the softening effect of cationic textile softeners even when used in baths containing little or no residual anionic surfactant. The other polysaccharide-based gums can be quaternized similarly and act substantially in the same way with varying degrees of effectiveness. Suitable starches and derivatives are the natural starches such as those obtained from maize, wheat, barley etc., and from roots such as potato, tapioca etc., and dextrins, particularly the pyrodextrins such as British gum and white dextrin.

Other suitable cationic polymers are described at paragraph [0317]-[0347] of U.S. Patent Publication 2003-0139312 A1, published Jul. 24, 2003, and the references cited therein

Of course, mixtures of any of the above described (or incorporated by reference) cationic polymers can be employed, and the selection of individual polymers or of particular mixtures can be used to control the physical properties of the compositions such as their viscosity and the stability of the aqueous dispersions.

When cationic polymer is included in the concentrated FSA composition of the present invention, it is included at a level of at least 1% and preferably greater than about 20%, preferably less than about 10% of the weight of the said concentrated composition.

When cationic polymer is included in the fabric softening composition of the present invention, the cationic starch is included at a level of at least about 0.1%, preferably at least about 0.5% and ≦about 5% of the weight of the said fabric care composition.

7. Whiteness Preservation Agents

In one embodiment of the invention, the composition comprises a whiteness preservative agent. Whiteness preservation agents include optical brighteners, bluing agents and UV absorbers as described herein below. When a whiteness preservation agent is included in the concentrated FSA composition of the present invention, it is preferably included at level less than about 10%, more preferably less than about 5%, even more preferably less than about 1% and typically at a level greater than about 0.01% by weight of the said concentrated composition. When a whiteness preservation agent is included in a fabric softening composition of the present invention, it is included typically at a level of less than about 3%, preferably less than about 1% and typically at a level of more than about 0.005% preferably more than about 0.05% by weight of the fabric softening composition.

Brighteners

Optical brighteners also known as fluorescent whitening agents (FWAs) or fluorescent brighteners preserve whiteness by compensating for the yellow appearance by adding a complementary color to the fabric and thus the undesired yellowing is rendered invisible. Not to be bound by theory, but auto-oxidation of the polyunsaturated softener compounds generates compounds that appear yellow on white fabrics because these compounds absorb short-wavelength light, light in the range of violet to blue or wavelengths between about 370 nm to 550 nm. Optical brighteners replace this missing part of the spectrum and so a white appearance is retained. Optical brighteners absorb light shorter wavelength ultraviolet light and emit light via fluorescence in the blue to blue violet range of the spectrum.

Preferred optical brighteners are colorless on the substrate and do not absorb in the visible part of the spectrum. Preferred optical brighteners are also lightfast, meaning that these do not degrade substantially in sunlight. Optical brighteners suitable for use in this invention absorb light in the ultraviolet portion of the spectrum between 275 nm and about 400 nm and emit light in the violet to violet-blue range of the spectrum from about 400 nm to about 550 nm. Preferably, the optical brightener will contain an uninterrupted chain of conjugated double bounds. Optical brighteners are typically, but not limited to, derivatives of stilbene or 4,4′-diaminostilbene, biphenyl, five-membered heterocycles such as triazoles, oxazoles, imidiazoles, etc., or six-membered heterocycles (coumarins, naphthalamide, s-triazine, etc.). Brightens suitable for compositions of the present invention include those disclosed in U.S. Pat. No. 5,861,370 by T. Trinh et al. 19 Jan. 1999 from column 10 line 40 to column 11 line 17 and U.S. Pat. No. 5,759,990 at column 21, lines 15-60. Suitable optical brighteners are also more fully described in Ullman's Encyclopedia of Industrial Chemistry, 5^{th} Edition, Vol. A18, Pages 153 to 176. and in The Kirk-Othmer Encyclopedia of Chemistry 3^{rd} Ed., pp 214-226 and in references therein; said references being incorporated herein by reference as suitable for use in this invention. Ionic brighteners with a positive or negative charge are preferred as this improves solubility in the compositions disclosed herein and thus are easier to formulate and are more stable. Cationic brighteners are also preferred since these can compete effectively with cationic fabric softeners to partition to the surface of the fabric.

Some preferred, but nonlimiting brighteners are Optiblanc® GL and Optiblanc® LSN from 3V Inc., Weehawken, N.J., Tinopals® CBS SP Slurry 33, PLC, UNPA-GX, 4BM, 4BMS, 5BM, 5BMS, 5BM-GX, AMS-GX, DMS-X, DCS Liquid, K, ERN, LCS, LFW, and TAS, Univex®, SK, ERN, and AT, from Ciba, High Point, N.C., Blankophor® FBW, FB, LPG, and HRS, from Mobay. In addition to preventing auto-oxidation, some brighteners also prevent dye transfer.

Bluing Agents

Bluing agents also act to preserve whiteness by compensating for the yellow appearance by again adding a complementary color to the fabric and thus the undesired yellowing is no longer noticeable. Like optical brighteners, bluing agents replace this missing part of the spectrum and so a white appearance is retained. Typically, the water soluble blue dyes that are used as bluing agents are anionic and associate with cationic softener actives and thereby deposit on fabric along with the softener active(s). Examples are Polar Brilliant Blue (Acid Blue 127:1), Liquitint Patent Blue, and Liquitint Blue 65, all from Milliken & Company and Acid Blue 80 from the Hilton-Davis Co., Cincinnati, Ohio. Oil soluble blue dyes and pigments can also be used.

UV Absorbers.

Not to be bound by theory, but UV absorbers can operate by protecting the fabric and any fabric softener compound deposited on the fabric from UV exposure. UV light is know to initiate auto-oxidation processes and suprisingly, UV absorbers can be deposited on fabric in such a way that UV light is blocked from the fabric and fabric plus composition thus preventing the initiation of auto-oxidation.

Preferably the UV absorber compound absorbs light at a wavelength of from about 315 nm to about 400 nm and is a preferably solid having a melting point of from about 25° C. to about 75° C., more preferably from about 25° C. to about 50° C. Preferred UV absorber agents of the present invention are selected from the group consisting of fatty derivatives of PABA, benzophenones, cinnamic acid, and phenyl benzotriazoles, specifically, octyl dimethyl PABA, dimethyl PABA lauryl ester, dimethyl PABA oleoyl ester, benzophenone-3 coco acetate ether, benzophenone-3 available under the tradename Spectra-Sorb® UV-9 from Cyanamid, 2-(2′-Hydroxy-3′,5′-di-tert-amylphenyl benzotriazole which is available under the tradename Tinuvin® 328 from Ciba-Geigy, Tinuvin® coco ester 2-(2′-Hydroxy, 3′-(coco dimethyl butanoate)-5′-methylphenyl) benzotriazole, and mixtures thereof. Preferred UV absorbers agents of the present invention are benzotriazole derivatives since these materials absorb broadly throughout the UV region. Preferred benzotriazole derivatives are selected from the group consisting of 2-(2′-Hydroxy, 3′-dodecyl, 5′-methylphenyl) benzotriazole available under the tradename Tinuvin®571 (Ciba) available from Ciba-Geigy, and Coco 3-[3′-(2H-benzotriazol-2′-yl)-5-tert-butyl-4′-hydroxyphenyl] propionate. Preferred UV absorbers are described in more detail in WO 0134743 A1 N.Y. Sakkab et al. published 7 May 2001 (Case 7851papp) p. 51 line 23 to p. 55 line 23 and these are included by reference herein.

8. Stabilizers

The term “stabilizer,” as used herein, includes antioxidants and reductive agents. Stabilizers while optional in concentrated FSA compositions and optional in fabric softener compositions are highly desirable both types of compositions. Antioxidants and reductive agent stabilizers preserve the characteristics of the said concentrated compositions. Antioxidants and reductive agent stabilizers are especially critical for unscented or low scent products (no or low perfume).

Examples of antioxidants that can be added to the dispersion compositions include a mixture of ascorbic acid, ascorbic palmitate, propyl gallate, available from Eastman Chemical Products, Inc., under the trade names Tenox® PG and Tenox® S-1; a mixture of BHT (butylated hydroxytoluene), BHA (butylated hydroxyanisole), propyl gallate, and citric acid, available from Eastman Chemical Products, Inc., under the trade name Tenox®-6; butylated hydroxytoluene, available from UOP Process Division under the trade name Sustane® BHT; tertiary butylhydroquinone, Eastman Chemical Products, Inc., as Tenox® TBHQ; natural tocopherols, Eastman Chemical Products, Inc., as Tenox® GT-1/GT-2; and butylated hydroxyanisole, Eastman Chemical Products, Inc., as BHA; long chain esters (C₈-C₂₂) of gallic acid, e.g., dodecyl gallate; Irganox® 1010; Irganox® 1035; Irganox® B 1171; Irganox® 1425; Irganox® 3114; Irganox® 3125; and mixtures thereof; preferably Irganox® 3125, Irganox® 1425, Irganox® 3114, and mixtures thereof; more preferably Irganox® 3125 alone or mixed with citric acid and/or other chelators such as isopropyl citrate, Dequest® 2010, available from Monsanto with a chemical name of 1-hydroxyethylidene-1,1-diphosphonic acid (etidronic acid), and Tiron®, available from Kodak with a chemical name of 4,5-dihydroxy-m-benzene-sulfonic acid/sodium salt and DTPA.RTM., available from Aldrich with a chemical name of diethylenetriaminepentaacetic acid. For further examples of suitable stabilizers see U.S. Pat. No. 5,574,179 Wahl et al., issued Feb. 28, 1995 incorporated herein by reference.

When stabilizers are included in the concentrated FSA compositions of the present invention, these are typically present at a level greater than about 0.005%, preferably greater than about 0.01%, and more preferably greater than about 0.1% and less than about 7% by weight of the said concentrated composition.

When stabilizers are included in the fabric softening composition of the present invention, these are typically present at a level of at least about 0.001%, more preferably at least about 0.01%, more preferably at least about 0.2% even more preferably at least about 0.035% and less than about 2%, more preferably less than about 1% of the final fabric softening composition.

9. Phase Stabilizing Polymers

A preferred phase stabilizing polymer is a copolymer having blocks of terephthalate and polyethylene oxide. More specifically, these polymers are comprised of repeating units of ethylene and/or propylene terephthalate and polyethylene oxide terephthalate at a molar ratio of ethylene terephthalate units to polyethylene oxide terephthalate units of from about 25:75 to about 35:65, said polyethylene oxide terephthalate containing polyethylene oxide blocks having molecular weights of from about 300 to about 2000. The molecular weight of this phase stabilizing polymer is in the range of from about 5,000 to about 55,000.

Another preferred phase stabilizing polymer is a crystallizable polyester with repeat units of ethylene terephthalate units containing from about 10% to about 15% by weight of ethylene terephthalate units together with from about 10% to about 50% by weight of polyoxyethylene terephthalate units, derived from a polyoxyethylene glycol of average molecular weight of from about 300 to about 6,000, and the molar ratio of ethylene terephthalate units to polyoxyethylene terephthalate units in the crystallizable polymeric compound is between 2:1 and 6:1. Examples of this polymer include the commercially available materials ZELCON® 4780 (from DuPont) and MILEASE® T (from ICI).

Highly preferred phase stabilizing polymers are described in more detail in U.S. Pat. No. 5,574,179 at col. 14, line 66 to col. 15, line 67; in U.S. Pat. No. 4,861,512; and in U.S. Pat. No. 4,702,857.

When phase stabilizing polymers are included in concentrated fabric softening actives of the present invention these are included at a level of at least about 0.5% and less than about 8% by weight of the said concentrated FSA composition.

When phase stabilizing polymer are included into fabric softening composition of the present invention, the said polymer is typically at a level of at least about 0.1% and less than about 10%, preferably less than about 2% of the weight of the said fabric softening composition. Phase stabilizing polymers useful in the present invention include copolymeric blocks of terephthalate and polyethylene oxide or polypropylene oxide, and the like. Preferred phase stabilizing polymers comprising cationic functionalities are disclosed in U.S. Pat. No. 4,956,447.

10. Optional Adjunct Ingredients

The present compositions optionally, but preferably, comprise additional adjunct ingredients, preferably selected from the group consisting of, fatty acid, dye, bluing agents, preservatives, antifoam agents, and mixtures thereof. The amount of each optional adjunct ingredient is typically up to about 15%, by weight of the concentrated FSA composition, and typically up to about 2% of the fabric softening composition unless otherwise specified.

When the present compositions comprise fatty acids, suitable fatty acids include those containing from about 12 to about 25, preferably from about 13 to about 22, more preferably from about 16 to about 20, total carbon atoms, with the fatty moiety containing from about 10 to about 22, preferably from about 10 to about 18, more preferably from about 10 to about 14 (mid cut), carbon atoms. The shorter moiety contains from about 1 to about 4, preferably from about 1 to about 2 carbon atoms. See e.g., EP 839,899. The soaps of the fatty acids disclosed herein are also suitable for the present invention.

### II. EXAMPLES

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

### Example 1

### Concentrated FSA Compositions

The following are non-limiting examples of the concentrated FSA compositions of the present invention. Examples 1A through I are made by bringing the fabric softener active and the solvent into a liquid state and then thoroughly mixing the components together into a homogeneous composition.

| | EXAMPLE | | | | | | | | |
|---|---|---|---|---|---|---|---|---|---|
| INGREDIENTS | A | B | C | D | E | F | G | H | I |
| Fabric Softening | 70.00% | 75.00% | 65.00% | 70.00% | 70.00% | 65.00% | 70.00% | 70.00% | 65.00% |
| Active ^{a} | | | | | | | | | |
| Ethanol | 1.00% | 2.00% | — | — | — | — | — | — | — |
| DEG ^{b} | 29.00% | — | — | — | — | | — | — | 30.00 |
| 1,2-Hexandiol | — | 23.00% | — | — | — | — | — | — | — |
| TMPD ^{c} | — | 1.58% | 35.00% | — | — | 10.00% | — | — | — |
| MP Diol ^{d} | — | — | — | 30.00% | — | — | — | — | — |
| DPG ^{e} | — | — | — | — | 30.00% | 23.00% | — | — | — |
| DOWANOL EPh | — | — | — | — | — | — | 30.00 | | 5.00 |
| glycol ether ^{f} | | | | | | | | | |
| Butoxytriglycol ^{g} | — | — | — | — | — | — | — | 30.00 | — |

^{a} The fabric softening active is chose from one of the following

| Fabric Softening Active | Iodine Value |
|---|---|
| N,N-di(tallowoyloxyethyl)-N,N-dimethylammonium chloride | About 50 |
| (mole ratio of monoester to diester of 1 to 1.3) | |
| N,N-di(tallowoyloxyethyl)-N,N-dimethylammonium chloride | ≦10 |
| (mole ratio of monoester to diester of 1 to 1.3) | |
| N,N-di(canola-oyloxyethyl)-N,N-dimethylammonium chloride. | ≧90 |
| Methyl bis(tallow amidoethyl)2-hydroxyethyl ammonium methyl sulfate | About 50 |
| Ditallowyl dimethylammonium chloride | About 50 |
| di-(hydrogenated tallowoyloxyethyl)-N,N-methylhydroxyethylammonium | About 60 |
| methylsulfate | |

^{b} Diethylene glycol
^{c} 2,2,4-trimethyl-1,3-pentanediol
^{d} 2-methyl-1,3-propanediol
^{e} dipropylene glycol
^{f} ethylene glycol phenyl ether
^{g} triethyl glycol monobutyl ether

### Example 2

### Fabric Softener Compositions

The following are nonlimiting examples of fabric softening compositions made from the concentrated fabric softening active.

| | EXAMPLE 2 | | | | | | | | |
|---|---|---|---|---|---|---|---|---|---|
| INGREDIENTS | A | B | C | D | E | F | G | H | I |
| Fabric Softening | 7.0% | 5.0% | 5.0% | 6.0% | 8% | — | — | — | — |
| Active ^{a} | | | | | | | | | |
| Fabric Softening | — | — | — | — | | 8% | — | 6.0% | — |
| Active ^{b} | | | | | | | | | |
| Fabric Softening | — | — | — | — | — | — | 8% | — | 7.0% |
| Active ^{c} | | | | | | | | | |
| EtOH | 0.1% | — | — | 0.1% | 0.1% | — | — | 0.1% | 0.1% |
| DEG | 2.9% | 2.3% | 2.3% | 3% | 2.9% | 2.3% | 2.3% | 3% | 2.9% |
| DOWANOL Eph | — | 0.38% | 0.38% | — | — | 0.38% | 0.38% | — | — |
| glycol ether | | | | | | | | | |
| Cationic Starch ^{d} | — | — | 0.75% | 0.5% | — | — | 0.75% | 0.5% | — |
| Perfume | 1.0% | 0.6% | 0.8% | 0.9% | 1.0% | 0.6% | 0.8% | 0.9% | 1.0% |
| Calcium Chloride | 0.15% | 0.12% | 0.12% | 0.15% | 0.15% | 0.12% | 0.12% | 0.15% | 0.15% |
| Preservative ^{h} | 7.5 ppm | 7.5 ppm | 7.5 ppm | 7.5 ppm | 7.5 ppm | — | — | 7.5 ppm | 7.5 ppm |
| Dye | 22 ppm | 22 ppm | 22 ppm | 22 ppm | 22 ppm | 11 ppm | 11 ppm | — | — |
| Deionized Water | Balance | Balance | Balance | Balance | Balance | Balance | Balance | Balance | Balance |

^{a} N,N-di(tallowoyloxyethyl)-N,N-dimethylammonium chloride, IV ≦ 10.
^{b} N,N-di(canola-oyloxyethyl)-N,N-dimethylammonium chloride.
^{c} Methyl bis(tallow amidoethyl)2-hydroxyethyl ammonium methyl sulfate.
^{d} Cationic starch based on common maize starch or potato starch, containing 25% to 95% amylose and a degree of substitution of from 0.02 to 0.09, and having a viscosity measured as Water Fluidity having a value from 50 to 84.
^{h} KATHON ® CG available from Rohm and Haas Co.

### Example III

### Making the Fabric Softening Composition from the Concentrated FSA Composition

The fabric softener composition of Example 2A is made by heating the concentrated FSA composition on of 1A to 74° C. A water seat of 1764.2 g and comprising 3 g CaCl₂ is weighed out and heated to 74° C. and placed in a reaction vessel. A dose of 285.7 g of the said liquid concentrated composition (70% active) held at 74° C. is pumped into the water seat in the reaction vessel while mixing with a IKA Labortechnik RW 20 DZM impellar mixer set at 800 RPM. After the composition is uniformly mixed minors, perfume (2 g), preservative (7.5 ppm), and dye (22 ppm) are added with continued mixing. Enough HCl is titrated into the composition to achieve a pH of 2.5 to 4. The composition is cooled to 20° C. by immersing a coil heat exchanger into the composition.

All documents cited in the Detailed Description of the Invention are, in relevant part, incorporated herein by reference; the citation of any document is not to be construed as an admission that it is prior art with respect to the present invention.

While particular embodiments of the present invention nave been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition comprising: (a) from 70% to 95% by weight of the composition of a quaternary ammonium compound suitable for softening fabric; and (b) from 5% to 30% by weight of the composition of a solvent comprising a Clog P of from about −2 to about 2;
wherein the compound comprises a monoester component and a diester component;
wherein the weight ratio of the monoester to the diester component is from about 15:85 to about 40:60 by the total weight of the quaternary ammonium compound, respectively;
wherein the Iodine Value (“IV”) of the quaternary ammonium compound is from about 1 to about 60;
wherein the composition comprises less than 5% by weight of the composition of water; and
wherein the composition comprises less than 5% by weight of the composition of a detergent surfactant

2. The composition of claim 1, wherein the solvent comprises diethylene glycol.

3. The composition of claim 1, wherein the composition is free of a perfume or dye.

4. The composition of claim 2, wherein the composition is free of a perfume or dye

5. The composition of claim 3, wherein the composition comprises less than about 3% by weight of the composition of water.

6. The composition of claim 5, wherein the composition comprises less than about 3% by weight of a detergent surfactant.

7. The composition of claim 6, wherein the composition comprises less than about 1% by weight of the composition of water.

8. The composition of claim 2, wherein the composition further comprises from about 1% to about 10% by weight of the composition of a cationic starch.

9. The composition of claim 5, wherein the composition further comprises from about 1% to about 10% by weight of the composition of a cationic starch.

10. The composition of claim 7, wherein the composition further comprises from about 1% to about 10% by weight of the composition of a cationic starch.
